(19) United States
(12) Patent Application Publication
(10) Pub. No.: US 2012/0080821 A1
(43) Pub. Date: Apr. 5, 2012

(54) MOLD RELEASE SHEET

(75) Inventors: Kurtis Zetouna, Waterford, MI (US); Shawn L. McCalvin, Mooresville, NC (US); Jarrod Fenton, Mooresville, OH (US)

(73) Assignee: CVG MANAGEMENT CORPORATION, New Albany, OH (US)

(21) Appl. No.: 13/224,499

(22) Filed: Sep. 2, 2011

Related U.S. Application Data
(60) Provisional application No. 61/379,957, filed on Sep. 3, 2010.

(51) Int. Cl. B29C 33/58; B28B 7/36

(52) U.S. Cl. 264/316; 425/89

(57) ABSTRACT

A system for molding is provides and includes a first mold portion and a second mold portion. The first and second mold portions facilitate formation of a molded panel. A first sheet is inserted between the first mold portion and the second mold portion, such that the first sheet facilitates removal of the molded panel from the first mold portion.

### CROSS-REFERENCE TO RELATED APPLICATIONS

This application claims the benefit of U.S. Provisional Patent Application Ser. No. 61/379,957 entitled “MOLD RELEASE SHEET” and filed on Sep. 3, 2010. The entirety of the above-noted application is incorporated by reference herein.

### ORIGIN OF THE INVENTION

The innovation disclosed herein generally relates to a multi-layered panel for a vehicle and more specifically to a headliner and method manufacture thereof for use in a passenger compartment of a truck, van or passenger vehicle.

### BACKGROUND

The passenger compartment of trucks, vans, and passenger vehicles (collectively, “vehicles”) typically includes a multi-layered panel that covers the interior roof of the vehicle. The panel, known as a headliner, is made of multiple layers of material such as foam, fiberglass, etc. formed or pressed into a single panel. The headliner serves several purposes, one of which is aesthetics. Specifically, the headliner covers the interior of the vehicle roof and as such, covers the sheet metal, wiring, etc. Further, the headliner includes a decorative layer, which is visibly exposed to the passengers, to provide an aesthetically pleasing interior for the passengers. Another function of the headliner is to provide a soft surface for the passengers in the event that a passenger of the vehicle contacts the headliner, to thereby minimize injury. Another function of the headliner is to provide thermal and sound insulation. Specifically, the headliner serves to insulate the passenger compartment from heat generated through the roof of the vehicle. The headliner also serves to insulate the passenger compartment from undesirable sounds generated by external forces (e.g., wind) or by the engine and the like.

Providing a headliner to simultaneously perform the above mentioned functions and manufacturing such a headliner is challenging. For example, it may be necessary to bend the headliner when installing the headliner in the cab of the vehicle. This may leave a crack in the headliner, which is visible through the decorative layer. Thus, the headliner needs to be flexible for installation purposes but must also be rigid or stiff enough to provide adequate protection to the passengers.

Conventional headliners are comprised of multiple layers of foam and fiberglass, as shown in FIG. 1. These conventional headliners 100 include multiple layers of foam, including an upper foam layer 102, a middle foam layer 104, and a lower foam layer 106. The headliner 100 further includes multiple layers of fiberglass, including an upper fiberglass layer 108 and a lower fiberglass layer 110. The foam layers are separated due to manufacturing reasons. Specifically, the upper foam layer 102 and the lower foam layer 106 are placed on the outer most portion of the headliner 100 to prevent fiberglass from collecting on saturation wheels of a saturator during manufacturing. The saturator saturates glass reinforcements with an activated resin, which is stored in a container. The resin is pumped from the container to saturation wheels where it is applied to the foam layers 102, 106. The use of a saturator is ideal for larger panels such as a headliner. Placing foam layers on the outer most portion of the headliner, however, compromises the integrity of the headliner.

Another manufacturing issue is that in conventional headliner molding techniques, a liquid mold release agent is used to aid in the release of a three dimensional part from a mold. Conventionally, liquid silicone (or other alternative material) is used to aid in the release of the part from the mold. The liquid silicon can be applied in several different ways. For example, the liquid silicone may be applied to the mold or to the part itself either by spraying or dipping the part in the release solution. One issue, however, with the release agent is that the release agent stains the surface of the headliner, resulting in an undesired surface quality.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In one aspect of the innovation a system for molding is provides and includes a first mold portion and a second mold portion. The first and second mold portions facilitate formation of a molded panel. A first sheet is inserted between the first mold portion and the second mold portion, such that the first sheet facilitates removal of the molded panel from the first mold portion.

In another aspect of the innovation, a method of molding is provided and includes placing a panel on the top surface of a second mold portion, placing a first sheet between the panel and a first mold portion, molding the panel via bringing the first mold portion and the second mold portion together to compress the panel, and removing the panel from the first mold portion and the second mold portion. The first sheet facilitates removal of the panel from the first mold portion.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is an illustration of a conventional multi-layered panel manufactured using conventional methods.

FIG. 2 is an illustration of a multi-layered panel in accordance with the innovation.

FIG. 3 is an illustration of example embodiments of fiber content and orientation in accordance with innovation.

FIG. 4 is an illustration of example embodiments of fiber content and orientation in accordance with innovation.

FIG. 5 is an illustration of a multi-layered panel requiring a protective layer in accordance with the innovation.

FIG. 6 is an illustration of a multi-layered panel without a protective layer in accordance with the innovation.

FIG. 7 is an illustration of a molding process of the multi-layered panel in accordance with the innovation.

FIG. 8 is an illustration of a mold to mold the multi-layered panel in accordance with the innovation.

FIG. 9 is an illustration of a schematic block diagram of an exemplary computing system in accordance with the innovation.

FIG. 10 is an illustration of a schematic block diagram of a computer operable to execute the computing system in accordance with the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

While specific characteristics are described herein (e.g., thickness), it is to be understood that the features, functions and benefits of the innovation can employ characteristics that vary from those described herein. These alternatives are to be included within the scope of the innovation and claims appended hereto.

Further, in view of the aspects and features described, methodologies that may be implemented in accordance with embodiments of the subject innovation will be better appreciated with reference to the figures. While for purposes of simplicity of explanation, the methodologies are shown and described as a series of drawings representing steps or acts associated with the methodologies, it is to be understood and appreciated that the claimed subject matter is not limited by the order of the drawings, as some drawings may occur concurrently with other drawings and/or in different orders than what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated drawings may be required to implement the methodologies described hereinafter.

The innovation described herein and shown in the figures, in one aspect thereof, is representative of an improved multi-layered panel and method of manufacturing thereof. FIG. 2 illustrates a multi-layered panel 200 for use in a truck, van or passenger vehicle (collectively, “vehicles”) in accordance with the innovation disclosed herein. The multi-layered panel 200 may be any type of multi-layered panel for use in the vehicles, such as but not limited to a headliner, a door panel, etc. Further, the shape of the multi-layered panel 200 shown in the figures is for illustrative purposes only as each truck, van or passenger vehicle will have its own distinctive shape.

The multi-layered panel 200 includes a first layer 202, a second layer 204, and an intermediate layer 206 disposed between the first layer 202 and the second layer 204. The first layer 202 and/or the second layer 204 may be any suitable fiber reinforced plastic material, such as but not limited to fiberglass. In the embodiment described herein and shown in the figures, the first and second layers 202, 204 are made of fiberglass. Thus, the embodiment described herein and shown in the figures is for illustrative purposes only and is not intended to limit the scope of the innovation. Further, the intermediate layer 206 may be comprised of foam or any other suitable polyurethane material.

One function of the intermediate layer 206 is to keep the first and second fiberglass layers 202, 204 separated so that the multi-layered panel 200 behaves as a single unit. Further, disposing the intermediate layer 206 between the first and second fiberglass layers 202, 204 increases the stiffness of the multi-layered panel 200. Specifically, because fiberglass is more dense than the intermediate layer and because the fiberglass layers 202, 204 are now the outermost layers, the second moment of area increases, thereby increasing the rigidity or stiffness of the multi-layered panel 200.

The second moment of area for a rectangular cross section is determined by multiplying the base (b) of the material by the height (h) of the material cubed and dividing the result by 12. Specifically, the formula for the second moment of area is I=bh³/12. The value of the second moment of area is theoretically improved by increasing the distance between the outermost layers, thereby increasing the height of the material between the first and second fiberglass layers 202, 204.

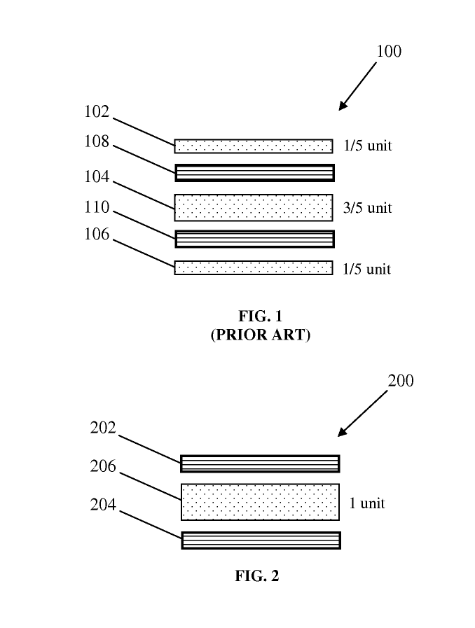

Referring back to FIG. 1, in the conventional headliner 100, the foam layer was separated into three different layers. The upper and lower layers 102, 106 each made up ⅕^{th} of the total foam and the middle layer made up ⅗^{th} of the total foam. In the innovation disclosed herein, the intermediate layer 206 is a whole unit or 5/5^{th} of the total intermediate layer 206. Thus, the material between the first and second fiberglass layer 202, 204 increased from ⅗^{th} of a unit to a whole unit ( 5/5^{th}). This increase in height in the intermediate layer 206 increased the second moment of area by a factor of 4.63. Increasing the second moment of area improves the rigidity of the multi-layered panel 200 but may also allow a reduction in cost by reducing the overall thickness or density of either the fiberglass layers 202, 204 or of the intermediate layer 206.

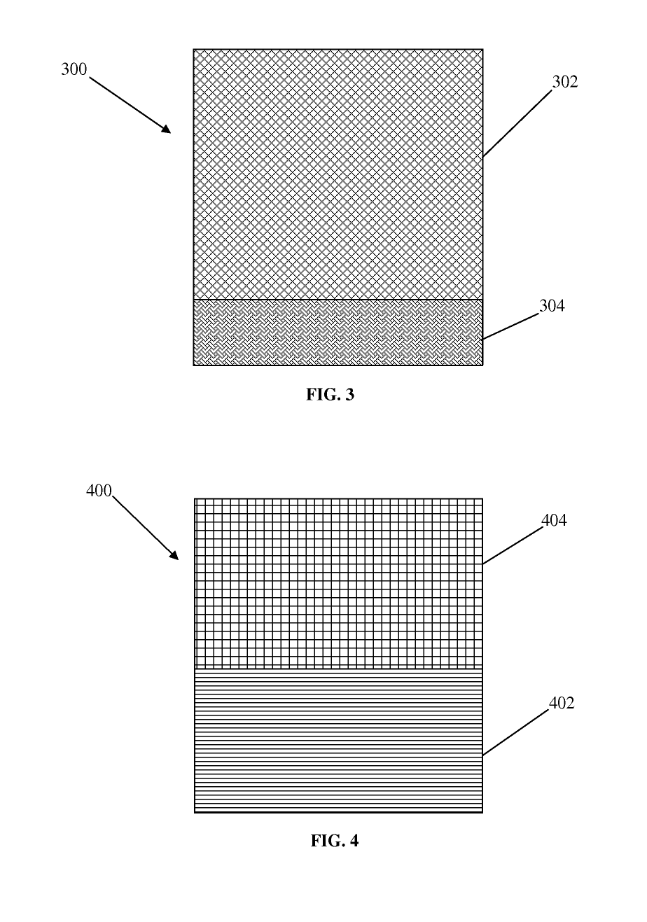

In one example embodiment, the first and second fiberglass layers 202, 204 are applied in a sheet fiberglass format, where the fibers are in the same plane. As a result, the concentration and orientation of the fibers in each sheet fiberglass can be tailored to specific customer requirements. For example, FIG. 3 shows sheet fiberglass 300 where the fibers are oriented in a cross-linked diagonal pattern 302 to increase the overall strength of the sheet fiberglass layers 202, 204. FIG. 3 further shows a second cross-linked pattern having higher amounts of fiber concentration 304 to provide additional strength. In another example, shown in FIG. 4, the fibers in the sheet fiberglass 400 can be made into short fiberglass lengths or continuous fiberglass strands, in either a unidirectional 402 or bi-directional fashion 404. The continuous fiberglass strands provide even more strength in a specific direction. This enables manufacturing costs to be reduced by using less glass, less foam and less resin, which penetrates and binds the entire multi-layered panel 200 together helping it to perform as a single unit.

Another advantage to the use of sheet fiberglass is that if the customer desires an increase in lateral strength, the first and/or second fiberglass layers 202, 204 can be designed to increase the lateral strength. The advantage of doing this is optimizing the amount of fiberglass and its contribution to the rigidity of the part. In addition, it is also possible to control the fiberglass concentration and orientation to make either the first or second fiberglass layer 202, 204 more rigid or softer than the other. For example, applications exist when certain portion or portions of the multi-layered panel 200 needs to be soft or flexible so as to facilitate its installation into the vehicle during the manufacturing process. Specifically, if the multi-layered panel is too large to install into the interior of the vehicle, the multi-layered panel 200 needs to be temporarily bowed to fit through a door or windshield of the vehicle.

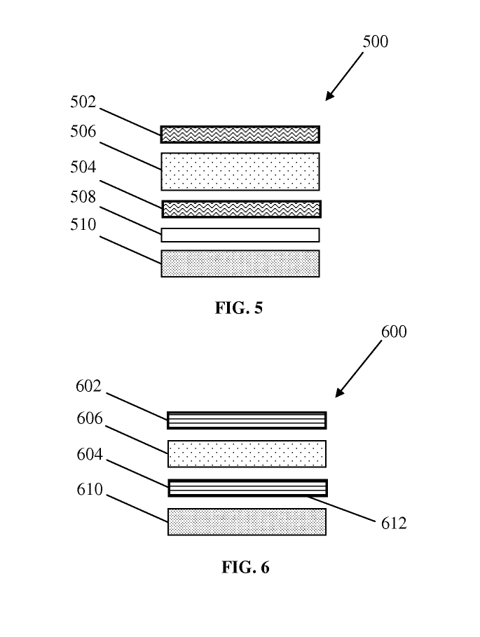

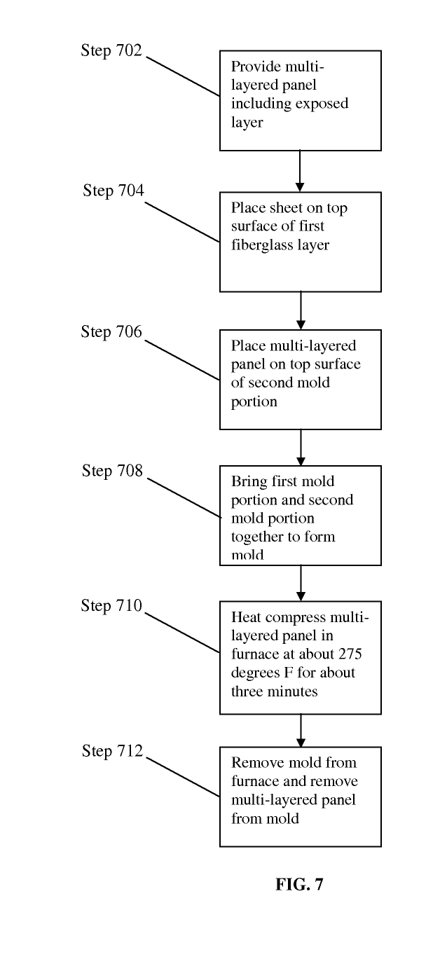

Still another advantage to the use of sheet fiberglass is that no protective layer is required between the first fiberglass layer and an exposed or decorative layer (face good), which is the layer exposed to the passengers. FIGS. 5 and 6 show a multi-layered panel 500, 600 utilizing chopped fiberglass and sheet fiberglass respectively. In FIG. 5 the multi-layered panel 500 includes a first chopped fiberglass layer 502, a second chopped fiberglass layer 504, and an intermediate layer 506 disposed between the first and second chopped fiberglass layers 502, 504. A protective layer 508 is provided between the first chopped fiberglass layer 502 and a decorative layer 510. A protective layer 508 is required because chopped fiberglass affects the quality of a surface of the decorative layer 510 that is visible to the passengers. In other words, chopped fiberglass does not have a smooth surface and requires an additional layer to smooth the visible surface of the decorative layer 510.

In FIG. 6, on the other hand, the multi-layered panel 600 includes a first sheet fiberglass layer 602, a second sheet fiberglass layer 604, and an intermediate layer 606 disposed between the first and second sheet fiberglass layers 602, 604. A decorative layer 610 is applied directly to a bottom surface 612 of the second sheet fiberglass layer 604. A protective layer is not required because sheeted fiberglass has a smoother flatter surface, which does not transfer its effects to the visible surface of the decorative layer 610.

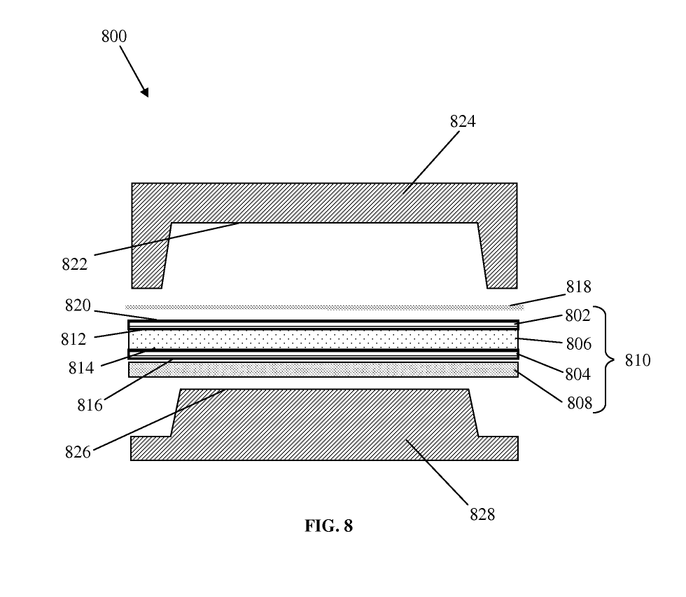

A method of molding the improved multi-layered panel disclosed above in a mold 800 will now be described with reference to FIGS. 7 and 8. At step 702, a first (upper) fiberglass layer 802, a second (lower) fiberglass layer 804, an intermediate layer 806, and a decorative layer 808 are provided and form an unmolded multi-layered panel 810. Specifically, the intermediate layer 806 is adhered to a bottom surface 812 of the first fiberglass layer 802 and to a top surface 814 of the second fiberglass layer 804. The decorative layer 808 is then adhered to a bottom surface 816 of the second fiberglass layer 804. The layers of the multi-layered panel 810 are secured together using an adhesive or the like. At step 704, a first sheet 818 is placed on a top surface 820 of the first fiberglass layer 802. The first sheet 818 may be made of plastic and may further be coated with a liquid solution, such as silicone, on one or both sides to help prevent the multi-layered panel 810 from sticking to a surface 822 of a first mold portion 824. At step 706, the multi-layered panel 810 is placed on a surface 826 of a second mold portion 828. At step 708, the first mold portion 824 and the second mold portion 828 are brought together and a pressure of approximately 5-20 tons is applied. The pressure applied within the multi-layered panel 810 may be in the range of 5-20 psi. At step 710, the compressed multi-layered panel 810 is heated in a furnace at a temperature of approximately 275 degrees F. for approximately three minutes. At step 712, the mold is removed from the furnace and the multi-layered panel 810 is removed from the mold 800.

The first sheet 818 aids in releasing the multi-layered panel 810 while simultaneously keeping the mold clean. Another advantage is that the first sheet 818 can be reused to save cost, until the release of the multi-layered panel 810 becomes difficult or the first sheet 818 breaks to the point where it is no longer usable. In use with Polyurethane multi-layered panels, this can be anywhere from 3 times to 50 or even 100 times. Further, it will be appreciated that the first sheet 818 may be used in other types of molding processes, such as but not limited to injection molding, transfer molding, etc. Still further, in some embodiments, a second sheet, similar to the first sheet 818 can be inserted between the decorative layer 808 and the second mold portion 828 to facilitate the removal of the multi-layered panel 810 from the second mold portion 828.

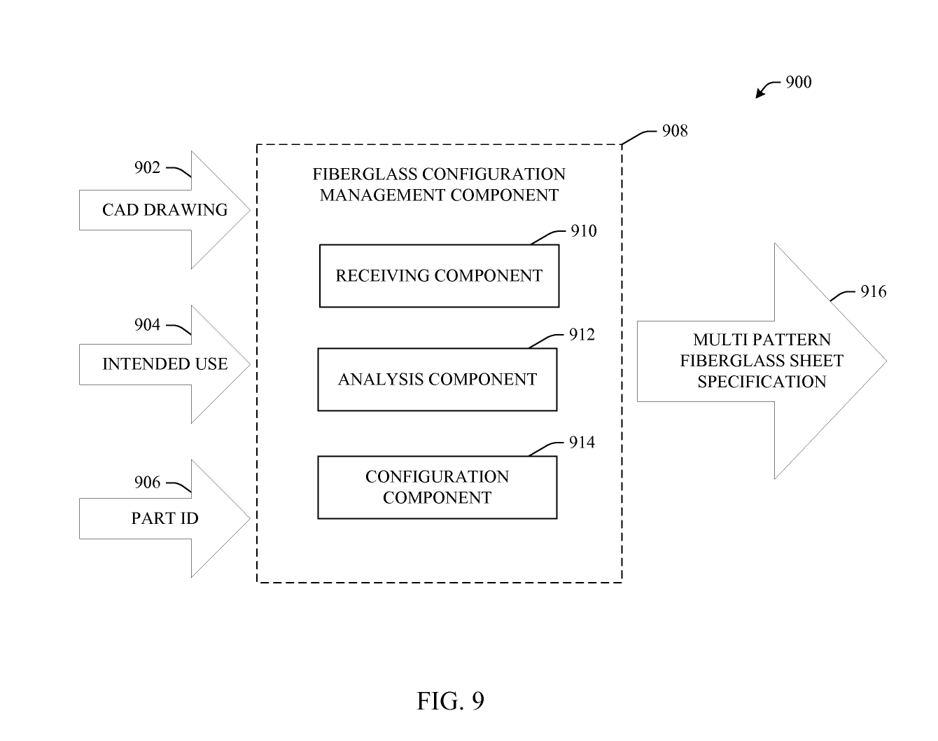

As described above and illustrated in FIGS. 3 and 4, an advantage to the use of sheet fiberglass is that the sheet fiberglass can have multiple fiberglass patterns (e.g. orientation and concentration) to provide the proper amount of rigidness or stiffness, strength or flexibility in different areas. With reference to FIG. 9, it will be appreciated that the fiberglass pattern in the sheet fiberglass can be automatically designed using computer automation. Specifically, a multi-pattern fiberglass sheet specification or design may be obtained with the analysis of various parameters input into a computer system 900. For example, some but not all input parameters may include information from a CAD drawing 902, the intended use 904 of the part, part identification 906, etc. Information from the CAD drawing 902 may include dimensions, locations of holes, locations of bends, etc. Intended use 904 may include information such as where the part will be installed in the vehicle, orientation of the part, how the part will interface with other parts in the vehicle, etc. The part identification 906 may include a part number, part description, the weight of the part, etc.

The input parameters may be input into a fiberglass configuration management component 908 of the computer system 900 where the information is processed. The fiberglass configuration management component 908 may include several processing components, such as but not limited to a receiving component 910, an analysis component 912, and a configuration component 914. The receiving component 910 receives the information from the input parameters and sends the input information to the appropriate component within the fiberglass configuration management component 908. The analysis component 912 analyzes the information from the input parameters to determine an optimum fiberglass pattern, which is described further below. Finally, the configuration component 914 configures the fiberglass pattern based on the resulting information from the analysis component 912.

The information from the fiberglass configuration management component 908 is output in the form of a specification. For example, the optimum fiberglass pattern may be output in the form of a multi-pattern fiberglass sheet specification 916, which is used to fabricate the part.

Referring again to FIGS. 3 and 4, the optimum fiberglass pattern may include one or more fiber patterns (orientations and/or concentrations) of fiberglass on a given sheet fiberglass 300, 400. Thus, there may be multiple fiber patterns that make up the entire sheet fiberglass pattern. Each fiber pattern may include more or less concentrations of fiberglass than the other fiber patterns based on the stiffness, strength and flexibility requirements of the sheet fiberglass. Further, each fiber pattern may have different fiberglass orientations than the other fiber patterns, again based on the stiffness, strength and flexibility requirements of the part, which is determined from the input parameters described above.

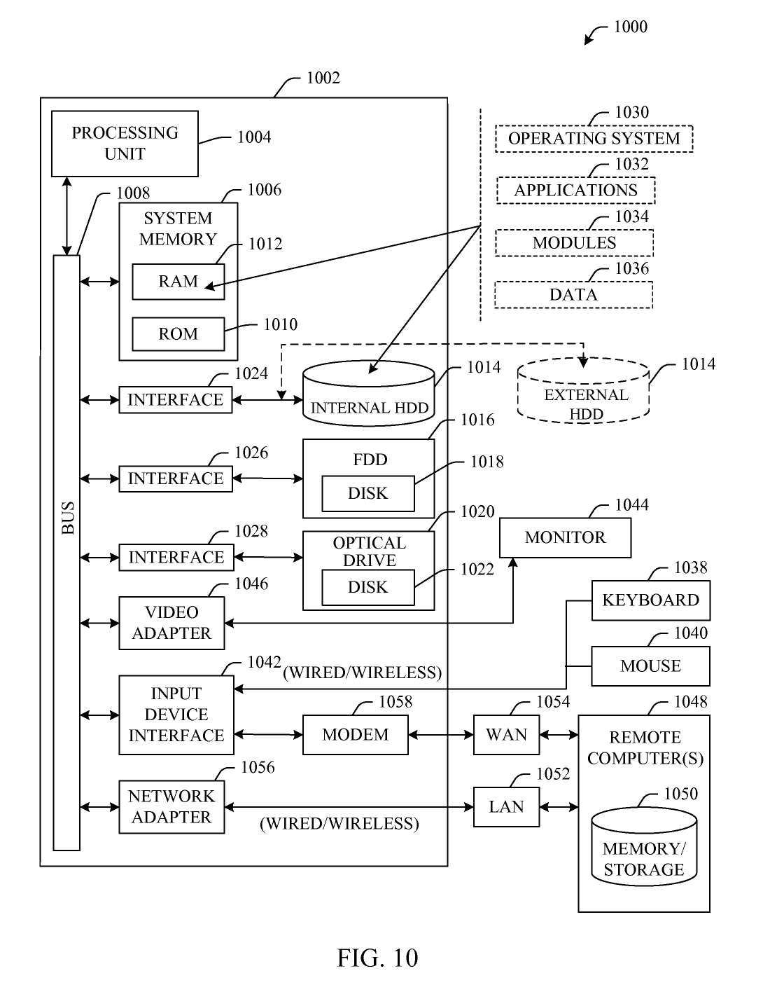

Referring now to FIG. 10, there is illustrated a block diagram of a computer operable to execute the disclosed architecture. In order to provide additional context for various aspects of the subject innovation, FIG. 10 and the following discussion are intended to provide a brief, general description of a suitable computing environment 1000 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for molding comprising:
a first mold portion and a second mold portion, wherein the first and second mold portion facilitate formation of a molded panel; and
a first sheet inserted between the first mold portion and the second mold portion, wherein the first sheet facilitates removal of the molded panel from the first mold portion.

2. The system of claim 1, wherein the first sheet comprises a plastic.

3. The system of claim 1, wherein the first sheet is coated in a liquid solution.

4. The system of claim 3, wherein the liquid solution comprises silicone.

5. The system of claim 1, further comprising a second sheet inserted between the first mold portion and the second mold portion, wherein the second sheet facilitates removal of the molded panel from the second mold portion.

6. The system of claim 1, wherein the molded panel is a multi-layered panel.

7. The system of claim 6, wherein the multi-layered panel comprises two layers of fiberglass and a single layer of foam.

8. The system of claim 1, wherein the molded panel is a headliner.

9. The system of claim 1, wherein the molded panel comprises at least one sheet fiberglass layer.

10. The system of claim 9, wherein at least one of the content or orientation of fibers in the sheet fiberglass layer have been selected to increase at least one of a strength or a flexibility of at least a portion of the sheet fiberglass layer.

11. The system of claim 1, wherein the first mold portion and the second mold portion form the panel via compression molding.

12. A method of molding, comprising:
placing a panel on the top surface of a second mold portion;
placing a first sheet between the panel and a first mold portion;
molding the panel via bringing the first mold portion and the second mold portion together to compress the panel; and
removing the panel from the first mold portion and the second mold portion, wherein the first sheet facilitates removing the panel from the first mold portion.

13. The method of claim 12, wherein molding the panel further comprises heating the panel in a furnace.

14. The method of claim 12, wherein the panel is a multi-layered panel.

15. The method of claim 14, wherein the multi-layered panel comprises two layers of fiberglass and a single layer of foam.

16. The method of claim 12, wherein the panel comprises at least one sheet fiberglass layer.

17. The method of claim 16, wherein at least one of the content or orientation of fibers in the sheet fiberglass layer have been selected to increase at least one of a strength or a flexibility of at least a portion of the sheet fiberglass layer.

18. The method of claim 12, wherein the first sheet comprises a plastic.

19. The method of claim 12, wherein the first sheet is coated in a liquid solution.

20. The method of claim 19, wherein the liquid solution comprises silicone.
